(19) United States
(12) Patent Application Publication
(10) Pub. No.: US 2006/0225776 A1
(43) Pub. Date: Oct. 12, 2006

(54) SKYLIGHT SOLAR PANEL ASSEMBLY

(75) Inventors: John E. Nemazi, Bloomfield Hills, MI (US); James W. Proscia, Dearborn, MI (US)

Correspondence Address: BROOKS KUSHMAN P.C., 1000 TOWN CENTER, TWENTY-SECOND FLOOR, SOUTHFIELD, MI, 48075, US

(73) Assignee: Portable Pipe Hangers, Inc., Houston, TX (US)

(21) Appl. No.: 11/279,062

(22) Filed: Apr. 7, 2006

Related U.S. Application Data
(60) Provisional application No. 60/669,632, filed on Apr. 8, 2005.

(51) Int. Cl. H02N 6/00

(52) U.S. Cl. 136/244

(57) ABSTRACT

A framed photovoltaic module having an integral transparent photovoltaic panel is provided. The framed photovoltaic module includes a plastic frame section that has an edge detail complementary to the edge detail of the photovoltaic panel. Skylight, doors and windows that include the framed photovoltaic module are also provided. The frame is made of reactive injection molding, injection molding, and the like.

### CROSS-REFERENCE TO RELATED APPLICATIONS

This application is claims the benefit of U.S. provisional application Ser. No. 60/669,632 filed Apr. 8, 2005.

### BACKGROUND OF THE INVENTION

1. Field of the Invention

The present invention relates to plastic molded frames having an integrated photovoltaic panel.

2. Background Art

The integration of photovoltaic devices into residential and commercial buildings in an aesthetically pleasing manner is important for the general acceptance of such devices. In many convention photovoltaic installations, solar cell panels are mounted on brackets fastened to rooftops in a manner that often contrast with the appearance of the building. Recently, an appreciation for masking solar cells in conventional building components has developed. Typically, such advanced materials are referred to as building-integrated photovoltaics (“BIP”). Examples of components with integrated photovoltaics include curtain walls, awning systems, rooftop arrays, skylights, atriums, and the like. Such components, however, tend to be expensive to fabricate while presenting complications for easily replacing defective or damaged solar cells.

Windows are integral parts of a variety of building components which include skylights, doors, conventional windows, and the like. Skylights, for example, have been used to allow light into residential and commercial buildings through an opening. The aesthetic value and possible health benefit of having sunlight in buildings have lead to an increasing demand for these structures. Ideally, a skylight will let light in while keeping other environmental elements out. Some window and skylight assemblies include either colored glass or low-e glass which passively enhance the solar control properties of the assemblies. However, few window assemblies with integrated active components are available. Moreover, the assemblies that do exist tend to be complicated and expensive to fabricate.

Skylights have been formed with components made by reaction injection molding (“RIM”). U.S. Pat. No. 5,061,531 (“the '531 patent”) discloses a framed insulating glass unit with an integral skylight frame and an integral curb made by the RIM process. In the framed insulating glass unit of the '531 patent, two glass plates are molded into a frame member by a polyurethane RIM process. RIM is a process of molding plastic parts using liquid monomers. It is capable of forming solid or foam parts that can vary from being flexible to extremely rigid. Polyurethanes are probably the most common plastics from which parts are made by the RIM process. RIM polyurethane is made by combining an isocyanate and a polyol.

In the typical RIM process, the liquids are pumped into and combined in a mixer under a pressure between about 1,500 and 3,000 psi. The liquids are then introduced into the mold under a low pressure (about 1 atm). An exothermic chemical reaction occurs in the mold causing the liquid to solidify without heating or cooling. Parts fabricated by RIM offer several advantages over other molding processes. Although parts produced by RIM are similar to parts made by injection molding, RIM parts may be made with shorter production time and less cost. Furthermore, RIM does not require high temperatures or pressures typical of injection molding thereby making it possible to make the molds out of inexpensive materials such as aluminum. However, the RIM process presents a number of considerations that complicate part fabrication. For example, the processing temperature, pressure and viscosity must be accurately controlled since the polymerization of the monomers takes place in the mold. Furthermore, the mixing head must be completely purged after each part is formed to prevent clogging. Finally, the relatively protracted cycle times for forming larger parts, and the limited choices of polymers (mostly polyurethanes) make RIM a somewhat undesirable process.

Accordingly, there exists a need for an improved construction component with integrated photovoltaic devices that are inexpensive to fabricate and aesthetically pleasing.

### SUMMARY OF THE INVENTION

The present invention overcomes one or more problems of the prior art by providing in at least one embodiment a framed photovoltaic module suitable for integration into a window-containing structure. The framed photovoltaic module of this embodiment includes a photovoltaic panel and a plastic frame section. The framed photovoltaic module of the present invention is characterized in having an outer peripheral edge section about which the plastic frame section is molded. Accordingly, the plastic frame section encapsulates and/or contacts the outer peripheral edge section. The framed photovoltaic module of this embodiment is advantageously integrated into any building component that typically includes a window or light-panel. Moreover, the framed photovoltaic module is advantageously used to mount photovoltaic panels to a building or on a array designed to hold photovoltaic panels. Such components include, but are not limited to, conventional window units, doors, skylights, and the like.

In another embodiment of the invention, methods for making the framed photovoltaic module set forth above is provided. The method of this embodiment includes molding by injection molding, vacuum molding, compression molding, or by RIM.

### BRIEF DESCRIPTION OF THE DRAWINGS

FIG. 1A is a cross-sectional view of an embodiment of the invention in which a photovoltaic panel is molded into a plastic frame section;

FIG. 1B is a cross-sectional view of another embodiment of the invention in which a photovoltaic panel is molded into a plastic frame section;

FIG. 2A is a cross-sectional view of an embodiment of the invention in which a photovoltaic panel along with a second substrate and spacer are molded into a plastic frame section;

FIG. 2B is a cross-sectional view of another embodiment of the invention in which a photovoltaic panel along with a second substrate and spacer are molded into a plastic frame section;

FIG. 3A is a cross-sectional view of an embodiment of the invention in which a photovoltaic panel along with a second substrate are molded into a plastic frame section that includes an integral spacer;

FIG. 3B is a cross-sectional view of another embodiment of the invention in which a photovoltaic panel along with a second substrate are molded into a plastic frame section that includes an integral spacer;

FIG. 4 is a cross-sectional view of an embodiment of the invention in which a photovoltaic panel laminated to a second light-panel is molded into a plastic frame section;

FIG. 5A is a cross-section of an embodiment of the invention that includes a stepped frame section and a spacer;

FIG. 5B is a cross-section of an embodiment of the invention that includes a stepped frame section with two substrates laminated together;

FIG. 5C is a cross-section of an embodiment of the invention that includes a stepped frame section and a spacer with a solar cell attached to the second substrate;

FIG. 6 is a schematic of a multi-layer solar cell that is used in one embodiment of the present invention; and

FIG. 7 is a perspective view of an embodiment of the present invention with a plastic frame and a curb adapted to be placed on a rooftop.

### DETAILED DESCRIPTION OF THE PREFERRED EMBODIMENTS

Reference will now be made in detail to presently preferred compositions or embodiments and methods of the invention, which constitute the best modes of practicing the invention presently known to the inventors.

As used herein, the term “light-panel” means a medium through which light is admitted. Such media include transparent or translucent glass and plastic panels.

As used herein, the term “photovoltaic panel” means a structure or assembly that includes at least one solar cell.

As used herein, the term “transmittance” means the percentage of incident visible light that is transmitted through an object. Formally, this is the amount of incident light (expressed as a percent) minus that amount reflected and absorbed.

In an embodiment of the present invention, a framed photovoltaic module is provided. The framed photovoltaic module of this embodiment includes a photovoltaic panel and a plastic frame section encapsulating and/or contacting an outer peripheral edge section of the photovoltaic panel. In at least one aspect of this embodiment, the window and skylight frames disclosed in U.S. patent application Ser. No. 10/639,410 filed on Aug. 12, 2003, and U.S. patent application Ser. No. 11/057,891 filed on Feb. 12, 2005 are used for the plastic frame sections in the present invention. The entire disclosures of each of these applications are hereby incorporated by reference. Specifically, the frame sections and curb sections of these applications are used in one embodiment of the present invention with a photovoltaic panel replacing at least one light panel or window.

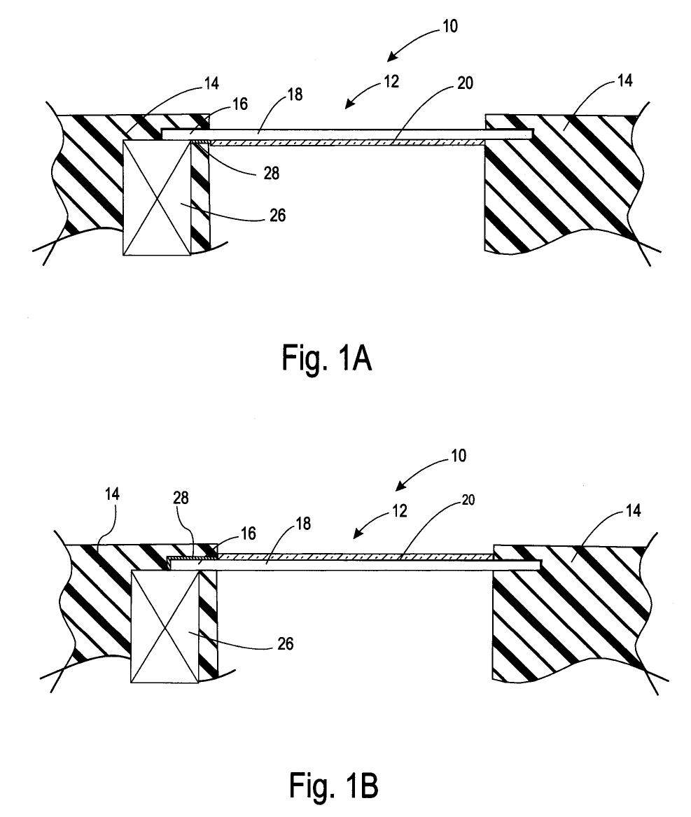

With reference to FIGS. 1A, 1B, 2A, 2B, 3A, and 3B, cross-sectional views of various framed photovoltaic modules embraced by the present invention are provided. With reference to FIG. 1A, framed photovoltaic module 10 includes photovoltaic panel 12 and plastic frame section 14. Plastic frame section 14 is molded to a portion of outer peripheral edge section 16 of photovoltaic panel 12. Photovoltaic panel 12 includes one or more solar cells. Virtually any solar cell design may be used in the practice of the invention. For example, crystalline silicon, polycrystalline silicon, amorphous silicon, copper indium diselenide, CdZnS/CuInGaSe₂, ZnCdS/CdTe, and gallium indium phosphide on gallium arsenide solar cells may be used. Moreover, thin film solar cells are particularly useful in the practice of the invention. In a variation of this embodiment, photovoltaic panel 12 includes substrate 18 with one or more solar cells 20 attached thereto. In a refinement, one or more solar cells 20 are attached to substrate 20 with an adhesive. In another refinement, one or more solar cells 20 are attached to substrate 20 with an adhesive. In still another refinement, one or more solar cells 20 are attached to substrate 20 by molding the solar cells into the substrate. Solar cells 20 may or may not extend to the outer edge of substrate 18 in this variation. In the variation of FIG. 1A, light must pass through substrate 18 before reaching one or more solar cells 20. Therefore, substrate 18 is typically first light-panel with high light transmission properties. Typically, the first light-panel transmits at least 50 percent of incident visible light. In most applications, the first light panel transmits greater than about 75 percent of incident visible light. Also schematically illustrated in FIG. 1A is the inclusion of electrical connector 26 within plastic frame section 14 which is in electrical contact with grid 28. Electrical connector 26 allows collection of the electricity generated by photovoltaic panel 12. Electrical connector 26 may be molded in place when plastic frame section 14 is molded. FIG. 1B provides a variation in which light is able to reach one or more solar cells 20 without passing through substrate 18. In this variation, one or more solar cells 20 are overcoated with a transparent protective layer. In this variation, substrate 18 can be either opaque or transparent. In window or skylight applications, portions of substrate 18 may not be covered with solar cells. In such refinements, substrate 18 is advantageously transparent in order to allow light to enter into a building.

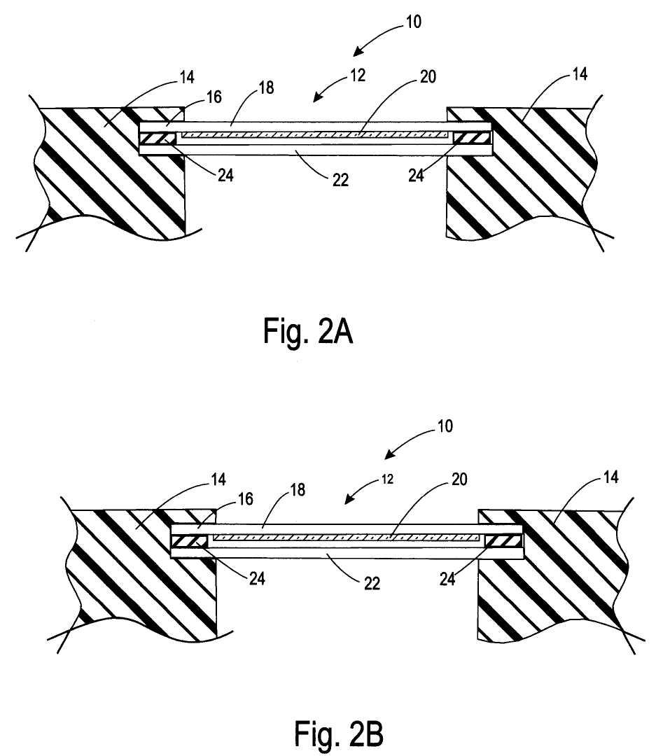

With reference to FIGS. 2A and 2B, variations of a framed photovoltaic module having two substrates are provided. FIG. 2A illustrates an embodiment in which framed photovoltaic module 10 further includes second substrate 22 with spacer 24 positioned between photovoltaic panel 12 and second substrate 22. In this variation, one or more solar cells are attached to substrate 18 as set forth in connection to the description of FIG. 1A. In a refinement of this variation, second substrate 22 is a light-panel that transmits visible light. FIG. 2B, provides a variation in which one or more solar cells 20 are attached to second substrate 22. In this variation, substrate 18 is again transparent (i.e., a light panel) while second substrate 22 can be either opaque or transparent (i.e., a second light panel). In window or skylight applications, portions of second substrate 22 may not be covered with solar cells. In such refinements, second substrate 22 is advantageously transparent in order to allow light to enter into a building.

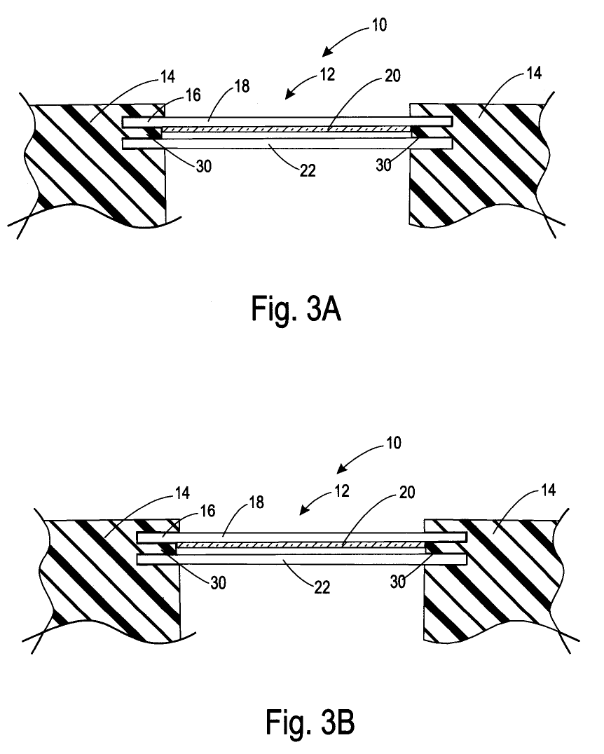

With reference to FIGS. 3A and 3B, variations of a framed photovoltaic module with a spacer section integral to and continuous with a plastic frame section are provided. In such variations framed photovoltaic module 10 includes a spacer section 30 that is integral to the plastic frame section 14. FIG. 3A provides a variation in which one or more solar cells 20 are attached to substrate 18. The details of this attachment and the properties of substrate 18 are the same as that set forth above in connection with the description of FIGS. 1A and 2A. FIG. 3B provides a variation in which one or more solar cells 20 are attached to second substrate 22. The details of this attachment and the properties of second substrate 22 are the same as that set forth above in connection with the description of FIG. 2B.

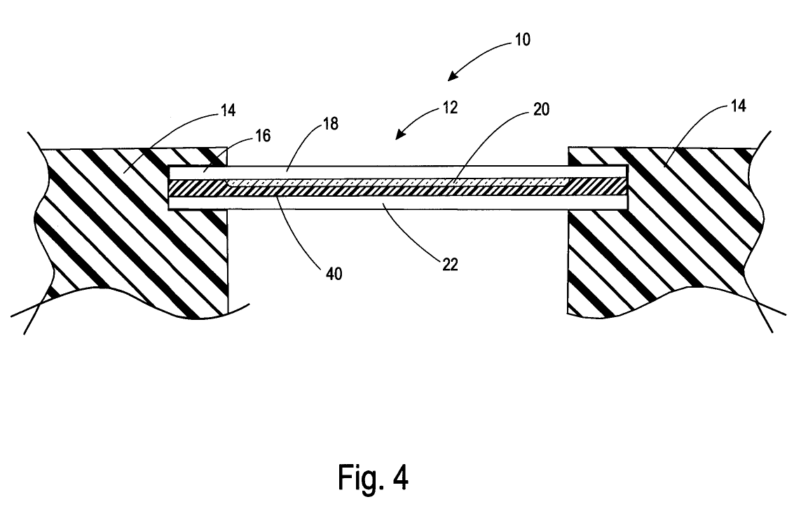

With reference to FIG. 4, an embodiment of the invention in which a solar panel is laminated to a second substrate is provided. In this embodiment, framed photovoltaic module 10 includes photovoltaic panel 12 and plastic frame section 14. As set forth above, plastic frame section 14 is molded to a portion of outer peripheral edge section 16 of solar panel 12. Photovoltaic panel 12 includes substrate 18 with one or more solar cells 20 attached thereto. Second substrate 22 is laminated to photovoltaic panel 12 by lamination layer 40. Lamination layer 40 is formed from any type of lamination material that does not appreciably degrade the performance of solar cells 20. Second substrate 22 can be either opaque or transparent (i.e., a light panel) as set forth above in connection with the description of FIG. 2A. When solar cells 20 are thin film solar cells, ethylene vinyl acetate (“EVA”) is an example of a laminate that can be used to laminate photovoltaic panel 12 to substrate 22.

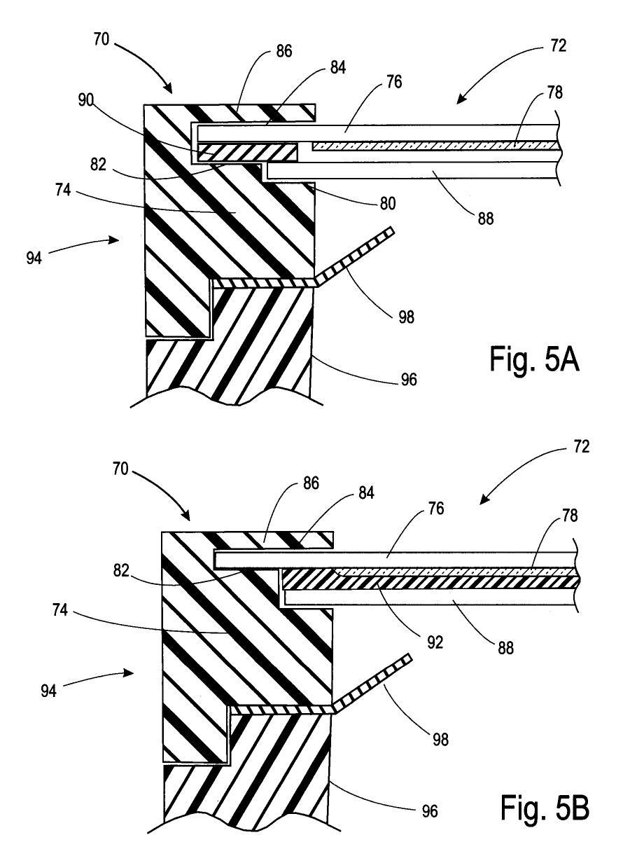

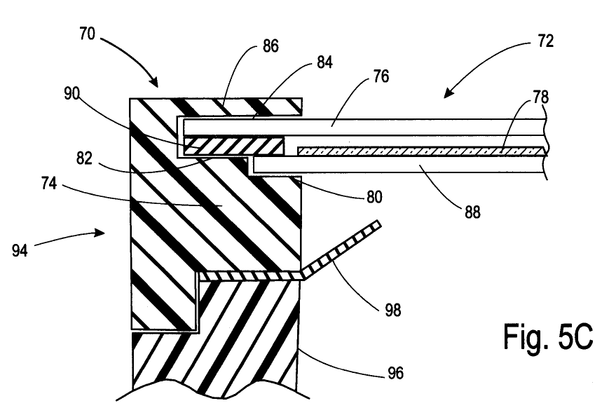

With reference to FIGS. 5A, 5B and 5C, a cross-section of an embodiment of the invention that includes a stepped frame section is provided. U.S. patent application Ser. No. 10/639,410 filed on Aug. 12, 2003 and U.S. patent application Ser. No. 11/057,891 filed on Feb. 12, 2005 discloses the utilization of using a step frame section in window applications which is extended by one or more embodiments of the present invention. In this embodiment, framed photovoltaic module 70 includes photovoltaic panel 72 and stepped frame section 74 (i.e., the plastic frame section). Photovoltaic panel 72 includes substrate 76 and one or more solar cells 78. As set forth above, substrate 76 is typically a first light-panel. Stepped frame section 74 includes lower step surface 80 and upper step surface 82. Optionally, stepped frame section 74 covers outer peripheral section 84 of photovoltaic module 70 with cover 86. Cover 86 is also integral to stepped frame section 74. Moreover, in some variations peripheral section 84 does not contain any solar cells. Framed photovoltaic module 70 also includes second substrate 88. Second substrate 88 can be either opaque or transparent (i.e., a second light panel). In window or skylight applications, portions of second substrate 88 may not be covered with solar cells. In such refinements, second substrate 22 is advantageously a light panel and transparent in order to allow light to enter into a building.

Still referring to FIG. 5A, first substrate 76 has a first length and a first width and second substrate 88 has a second length and a second width such that when photovoltaic panel 72 and second transparent panel are attached to stepped frame section 74, stepped frame section 74 has an edge detail complementary to the combined edge detail of photovoltaic panel and the second transparent substrate (and a spacer if present). Specifically, lower step surface 80 opposes a peripheral section of second substrate 88 and upper step surface 82 opposes either spacer 90 or a peripheral section of photovoltaic panel 72, or a portion of both spacer 90 and photovoltaic panel 72. Moreover, the first length is greater than the second length and the first width is greater than the second width.

With reference to FIG. 5B, a variation in which second substrate 88 and photovoltaic panel 72 are laminated together is provided. In this variation, laminate 92 is used to laminate photovoltaic panel 72 and second substrate 88 together. The lamination details are the same as those set forth above in connection with the description of FIG. 4.

With reference to FIG. 5C, a variation in which one or more solar cells 78 are attached to second substrate 88 is provided. The detail of this attachment are the same as those set forth above in connection with the description of FIG. 2B.

FIGS. 5A and 5B also provide a demonstration of the modular features of an embodiment of the invention which is important for the relatively easy and inexpensive replacement of damaged or defective solar cells. Photovoltaic frame 94 includes stepped frame section 74 with photovoltaic panel 72 and second light-panel 88 molded therein. Photovoltaic frame 94 is adapted to be placed against curb section 96 which may be placed on a roof, window or door. Drip drain 98 is optionally included in applications such as a skylight in which condensation may occur.

In FIGS. 1 through 5, the photovoltaic panel is such in some variations that the solar cell is positioned on an interior surface of a substrate. Specifically, light passes through the substrate before impinging on the solar cell. In should be appreciated that configurations in which the solar cell is positioned on an exterior substrate surface are also embraced by the present invention. For example, light will impinge on the solar cell before proceeding through the substrate. Accordingly, the following arrangements are included in the invention—solar cell attached to a first substrate contacting the plastic frame section of the invention; solar cell attached to a first substrate and a second substrate (with or without a spacer and with or without lamination as set forth above) contacting the plastic frame sections set forth above.

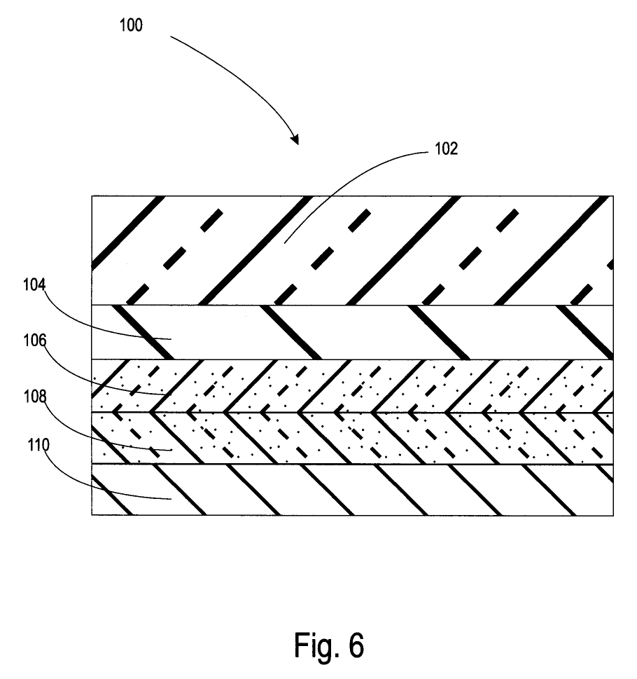

In an important variation of the present invention, the framed photovoltaic modules set forth above comprises one or more sections that are transparent. U.S. Pat. Nos. 4,663,495 and 6,180,871 disclose examples of transparent solar cells that are useful in the present invention. The entire disclosure of these patents are hereby incorporated by reference. In one variation, this transparency is achieved by providing sections of the photovoltaic module without any solar cell attached. In other variations, the one or more sections that are transparent have a transmittance of at least 1% (sum if more than one). In still other variations, the one or more sections that are transparent have a transmittance of at least 5% (sum if more than one). In still other variations, the one or more sections that are transparent have a transmittance of at most 20% (sum if more than one). In yet other variations, the one or more sections that are transparent have a transmittance of at most 15% (sum if more than one). Multi-film solar cells are particularly useful in achieving such transmittances when made sufficiently thin to allow some transmission of visible light. FIG. 6 provides a schematic cross-section of a multi-film solar cell that is used in an embodiment of the invention. Solar cell 100 includes first transparent substrate 102 over which first electrically conductive layer 104 is disposed. First doped silicon layer 106 is in turn disposed over at least a portion of first electrically conductive layer 104. Second doped silicon layer 108 is disposed over first doped silicon layer 106. Finally, second electrically conductive layer 110 disposed over second doped silicon layer 108. The first doped photovoltaic layer 106 and second doped photovoltaic layer 108 each individually comprise a component selected from the group consisting of crystalline silicon, amorphous silicon, and polycrystalline. Moreover, first doped photovoltaic layer 106 and second doped photovoltaic layer 108 each individually include an impurity selected from the group consisting of a p+ type impurity, a p type impurity, and an n type impurity. However, first doped photovoltaic layer 106 and second doped photovoltaic layer 108 must be doped in such a manner as to form a photovoltaically active junction. Typically, if first doped photovoltaic layer 106 is p type or p+ type, then second doped photovoltaic layer 108 is n type. Similarly, if first doped photovoltaic layer 106 is n type, then second doped photovoltaic layer 108 is p type or p+ type. Solar cell 100 includes first conductive layer 102 and second conductive layer 110. Examples of materials that can be used to form first electrically conductive layer 102 and second electrically conductive layer 110 are transparent electrical conductors which include indium tin oxide (“ITO”), doped tin oxide, doped zinc oxide, and combinations thereof. Moreover, when such transparent electrical conductors are employed, a set of metal grids attached thereto may optionally be used to assist in the collection of electricity. In some variations, metal grids may be substituted for the transparent electrical conductors.

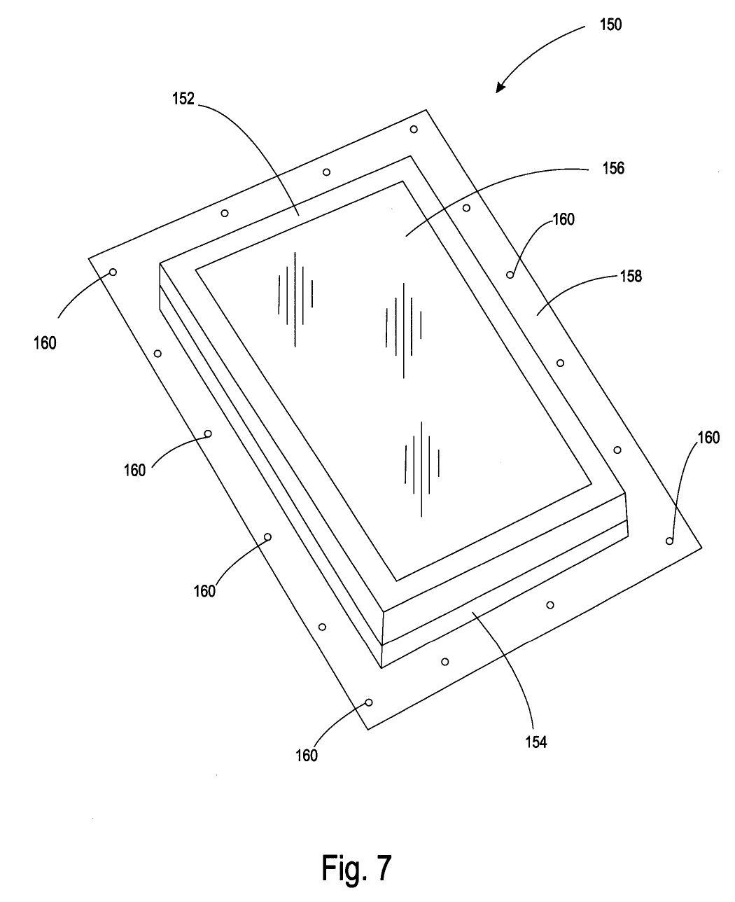

With reference to FIG. 7, an embodiment of the present invention in which the framed photovoltaic module of the invention is incorporated into a window-containing component such as a skylight is provided. Window assembly 150 includes photovoltaic frame 152 and curb 154. Photovoltaic frame 152 includes photovoltaic panel 156. Moreover, photovoltaic frame 152 includes the plastic frame section as set forth above. Similarly, the details of photovoltaic panel 156 are also the same as those set forth above. Curb 154 includes flange region 158 which may be placed on a rooftop and sealed in a manner known to those skilled in the art of skylight installation. Flange region 158 optionally includes holes 160 to allow fastening to a roof or other structure. In another variation of this embodiment, curb 154 and photovoltaic frame 152 are not separate pieces and are instead a single piece. It should also be appreciated that a series of wires used to collect electricity from photovoltaic panel 156 are in one variation positioned in one or more channels molded into the photovoltaic frame 152 and curb 154. In other variations, such wires are placed in the corners of the window assembly.

The frame photovoltaic modules set forth above are made by a variety of molding processes. For example, the photovoltaic modules of FIGS. 1-5 and 7 may be formed by injection molding, vacuum molding, compression molding, or by RIM. When the RIM process is used to form the photovoltaic modules of the invention, preferably, polyurethane is used as the material of construction. In such a process, an isocyanate component is reacted with an isocyanate-reactive component (i.e., a polyol) in a mold having an interior cavity complementary to the framed photovoltaic module. In the typical polyurethane producing process that is useful in the practice of the invention, an isocyanate and a polyol are reacted together. Isocyanate usable in the present invention include both multifunctinal aromatic isocyanate and multifuntional aliphatic isocyanates. Multfunctional isocyanates include diisocyanates, triisocyanates, and the like. Examples of useful isocyanates include, but are not limited to, toluene diisocyanate (“TDI”), methylene-4,4′-diphenyl diisocyanate (“MDI”), and a polymeric isocyanate (“PMDI”). Examples of polyols include, but are not limited to, polyethylene glycols and polyester polyols. Specific diols usable in the invention include, but are not limited to, ethylene glycol, diethylene glycol, 1,4-butanediol, 1,6-hexanediol, and the like. Also usable as the polyol are alcohol-terminated polyethers such as polyethylene oxide and polypropylene oxide and alcohol-terminated polyesters such as poly-1,4-butylene adipate. Usually, the reaction between the polyol and the isocyanate is carried out in the presence of catalysts. Various additives can be used to improve the fire performance, chemical stability, and the like. Polyurethanes made with aliphatic isocyanates are somewhat more useful due to the tendency of aromatic diisocyanates to yellow with exposure to light.

A particularly useful polyurethane composition and RIM molding process is provided by U.S. Pat. No. 6,242,555 (the '555 patent), the entire disclosure of which is hereby incorporated by reference. Specifically, in accordance with this process an isocyanate component containing an isophorone diisocyanate (IPDI) trimer/monomer mixture having an NCO content of from 24.5 to 34% by weight, is reacted with isocyanate-reactive components in the presence of at least one catalyst component, at least one pigment component, and at least one antioxidant/UV absorber component. The isocyanate-reactive components comprise a polyetherpolyol having terminal OH groups, an average nominal functionality of 2 to 4, and an average equivalent weight of from 800 to 4000; at least one chain extender component having as functional groups only aliphatic or alicyclic OH groups; and at least one amine-initiator component. The catalyst component is selected from the group consisting of organolead (II), organobismuth (III), and organotin (IV) catalysts.

The preferred molding process is chosen to improve strength and to minimize part weight and to provide optimum thermal insulation qualities. To this end, framed photovoltaic modules optionally include one or more hollow cores that may be filled with a foamed plastic. Framed photovoltaic modules with hollow cavities may be made by gas assisted injection molding which uses a conventional injection molding press equipped with a spillover control and a mold equipped with gas injection and spillover points. Suitable gas assisted injection molding processes which may be used to form the skylight frame-curb assembly of the present invention are described in U.S. Pat. No. 6,019,918. The entire disclosure of this patent is hereby incorporated by reference. The foam material is then introduced through inlet holes after the frame is molded. Alternatively, the part can be molded utilizing a plastic foaming agent, the surface of the plastic part having a smooth uniform skin while the inner core contains a series of gas bubbles forming a rigid foam or sponge-like core. The skylight frame-curb assembly may also be made by compression molding using either sheet molding compound (“SMC”) or bulk molding compound.

As set forth above, the RIM process is particularly useful in forming the framed photovoltaic modules of the invention. In such a process, an isocyanate component is typically reacted with an isocyanate-reactive component (i.e., a polyol) in a mold having an interior cavity with a region complementary to the framed photovoltaic modules. A particularly useful polyurethane composition and RIM molding process is provided by U.S. Pat. No. 6,242,555. The details of this process are set forth above and in this patent. Moreover, the application of one or more coupling agents prior to molding is found to further enhance adhesion when glass panels are used as part of the photovoltaic panel and the second light-panel. More preferably, two or more coupling agents are applied to the glass surfaces prior to molding of a construction incorporating the frame sections. The details of the coupling agents is the same as that set forth above. In a variation the glass panels are treated with one or more primers. Useful primers include one or more of the following components: organosilanes, polyurethanes, polyesters, pigments, and solvents. Examples of suitable primers include Betaseal™ 43518 Glass Primer and Betaseal™ 43520A Glass Primer commercially available from Dow Chemical Company. Betaseal™ 43518 Glass Primer is a proprietary composition which includes toluene, methyl alcohol, and an organosilane. Betaseal™ 43520A Glass Primer is a proprietary composition which includes toluene, methyl ethyl ketone, carbon black, n-butyl acetate, potassium oxide, xylene, polyurethane, polyester, and an organosilane. Typically, the glass is first treated with Betaseal™ 43518 Glass Primer and then Betaseal™ 43520A. It is readily apparent that these primers and in particular the Betaseal™ 43518 Glass Primer and Betaseal™ 43520A contain a number of components that improve adhesion of the RIM molded frame to the glass panels.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A framed photovoltaic module comprising:
a photovoltaic panel having an outer peripheral edge section; and
a plastic frame section molded about the outer peripheral edge section and having an edge detail complementary to the outer peripheral edge section of the photovoltaic panel.

2. The framed photovoltaic module of claim 1 wherein the plastic frame section comprises polyurethane.

3. The framed photovoltaic module of claim 2 wherein the plastic frame section is formed by reactive injection molding, injection molding, vacuum molding, or compression molding.

4. The framed photovoltaic module of claim 1 wherein the photovoltaic panel comprises one or more sections that are transparent.

5. The framed photovoltaic module of claim 4 wherein the one or more sections that are transparent have a transmittance of at least 1%.

6. The framed photovoltaic module of claim 4 wherein the one or more sections that are transparent have a transmittance of at least 5%.

7. The framed photovoltaic module of claim 4 wherein the photovoltaic panel comprises:
a first transparent substrate;
a first conductive layer disposed over the transparent substrate;
a first doped silicon layer disposed over the first conductive layer;
a second doped silicon layer disposed over the first doped silicon layer; and
a second conductive layer disposed over the second doped silicon layer.

8. The framed photovoltaic module of claim 7 wherein the first and second conductive layers each independently comprise a component selected from the group consisting of ITO, doped tin oxide, doped zinc oxide, and combinations thereof.

9. The framed photovoltaic module of claim 7 wherein the first and second doped silicon layers each individually comprise a component selected from the group consisting of crystalline silicon, amorphous silicon, and polycrystalline silicon.

10. The framed photovoltaic module of claim 9 wherein the first doped silicon layer comprises an impurity selected from the group consisting of a p+ type impurity, a p type impurity, and an n type impurity.

11. The framed photovoltaic module of claim 1 wherein the photovoltaic panel comprises a component selected from the group consisting of crystalline silicon solar cells, amorphous silicon solar cells, polycrystalline copper indium diselenide solar cells, CdZnS/CuInGaSe₂ solar cells, ZnCdS/CdTe solar cells, and gallium indium phosphide on gallium arsenide solar cells.

12. The framed photovoltaic module of claim 1 wherein the photovoltaic panel comprises a first substrate and one or more solar cells attached thereto.

13. The framed photovoltaic module of claim 12 further comprising a second substrate.

14. The framed photovoltaic module of claim 13 wherein the first substrate has a first length and a first width and the second substrate has a second length and a second width such the photovoltaic panel and second substrate are encapsulated by the plastic frame section, the plastic frame section has an edge detail complementary to the combined edge detail of photovoltaic panel and the second substrate, the first length being greater than the second length and the first width being greater than the second width.

15. The framed photovoltaic module of claim 12 wherein a spacer is interposed between the first substrate and the second substrate.

16. The framed photovoltaic module of claim 1 further comprising an integral curb section adapted to be placed on a rooftop.

17. A window unit comprising the framed photovoltaic module of claim 1.

18. A door comprising the framed photovoltaic module of claim 1.

19. A skylight comprising the framed photovoltaic module of claim 1.

20. A method of forming a framed photovoltaic module comprising a photovoltaic panel and a plastic frame section, the plastic frame section having an edge detail complementary to the edge detail to the photovoltaic panel, the method comprising:
a) reacting in a mold having an interior cavity complementary to the plastic frame section an isocyanate component with an isocyanate-reactive component.

21. The method of claim 20 wherein the plastic frame section has a stepped frame section having a lower step surface and an upper step surface, the lower step surface and the upper step surface complementary to the edge detail of photovoltaic panel.

22. The method of claim 20 wherein:
the isocyanate component comprises:
an isophorone diisocyanate (IPDI) trimer/monomer mixture having an NCO content of from 24.5 to 34% by weight; and
the isocyanate-reactive component comprises:
a polyetherpolyol having terminal OH groups, an average nominal functionality of 2 to 4, and an average equivalent weight of from 800 to 4000.
at least one chain extender component having as functional groups only aliphatic or alicyclic OH groups; and
at least one amine-initiator component; and
wherein step a is performed in the presence of:
at least one catalyst component selected from the group consisting of organolead (II), organobismuth (III), and organotin (IV) catalysts;
at least one pigment component, and
at least one antioxidant/UV absorber component.

23. The method of claim 20 wherein the plastic frame section is molded in contact with the photovoltaic panel.

24. The method of claim 20 wherein the framed photovoltaic module further comprises a second transparent panel.

25. The method of claim 24 wherein the first and second transparent substrates are each treated by one or more primers comprising one or more components selected from the group consisting of organosilanes, polyurethanes, polyesters, pigments, solvents, and combinations thereof.
